(19) United States
(12) Patent Application Publication
(10) Pub. No.: US 2014/0235361 A1
(43) Pub. Date: Aug. 21, 2014

(54) Torque Shaft and Torque Shaft Drive

(71) Applicant: CARDIACMD, INC., Los Altos Hills, CA (US)

(72) Inventors: David C. Forster, Menlo Park, CA (US); Brian Beckey, Woodside, CA (US); Brandon G. Walsh, Syracuse, UT (US); Scott Heneveld, Whitmore, CA (US); Alex Roth, Redwood City, CA (US)

(21) Appl. No.: 13/768,166

(22) Filed: Feb. 15, 2013

(51) Int. Cl. F16C 1/04

(52) U.S. Cl. CPC F16C 1/04
USPC 464/149

(57) ABSTRACT

Torque shafts and other related systems and methods are described herein. The torque shafts are both flexible and capable of transmitting torque. The torque shafts are useful for procedures that require torque and pushability to drive or deploy a device. The flexibility and pushability of the torque shafts enable them to curve along a tortuous path, and the torque transferring capability of the shafts enable them to transmit torque along the shaft.

### CROSS-REFERENCE TO RELATED APPLICATIONS

This application is a continuation of U.S. application Ser. No. 12/305,620, filed Dec. 18, 2008, now U.S. Pat. No. 8,376,865, which is a national stage entry under 35 U.S.C. Section 371 of PCT Application Serial No. PCT/US2007/071535, filed Jun. 19, 2007, which claims priority to U.S. Provisional Application Ser. No. 60/805,334, filed Jun. 20, 2006, all of which are incorporated herein by reference in their entirety.

### BACKGROUND OF THE INVENTION

Typical flexible shafts are susceptible to torque to the extent that rotation of one side of the shaft does not correlate to rotation of the opposite side of the shaft. For instance, in applications where a shaft is used to transmit torque along a tortuous path to a remote device, it is desirable to maintain a correlation between rotation on one side of the shaft to rotation at the remote device such that the amount of rotation at the remote device can be tracked with certainty. Typical shafts are susceptible to buckling, kinking or require an excessive amount of initial rotation at the outset before correlatable torque transmission occurs. Accordingly, there is a need for a flexible shaft that transmits torque with improved certainty, adequacy and/or efficiency.

### BRIEF SUMMARY OF THE INVENTION

Described herein are systems and methods for the transmission of torque and translation of movement in the context of torque. Exemplary embodiments of torque shafts and systems and methods making use of those shafts are described, as well as others.

### BRIEF DESCRIPTION OF THE DRAWINGS

FIGS. 1A-1C show a torque shaft with T-shaped interlocking features according to an embodiment.

FIGS. 2A-2B show a torque shaft with teardrop shaped interlocking features according to another embodiment.

FIG. 3 illustrates the torque transferring capability of the torque shaft.

FIG. 4 shows a torque shaft with spiral slots running the length of the torque shaft.

FIGS. 5-6 show a spot-link torque shaft according to another embodiment.

FIG. 7 shows a torque shaft with living hinges according to another embodiment.

FIGS. 8-9 show two opposing torque shafts according to another embodiment.

FIG. 10 shows a pull-pull torque drive according to another embodiment.

FIG. 11 shows a device for translating axial force applied to the shaft into rotational movement of the shaft.

### DETAILED DESCRIPTION OF THE INVENTION

Torque shafts are described herein. The torque shafts are both flexible and capable of transmitting torque. The torque shafts are useful for procedures that require torque and pushability to drive or deploy a device in any application, such as a medical application constituting use in a patient's body. The flexibility and pushability of the torque shafts enable them to curve along passageways in the body, and the torque transferring capability of the shafts enable them to transmit torque in the body to drive or deploy a device in the body. The torque shafts are particularly useful for the deployment of prosthetic heart valves in a patient's heart, which are described in greater detail in application Ser. No. 11/066,126, titled “Prosthetic Heart Valves, Scaffolding Structures, and Systems and Methods for Implantation of Same,” filed on Sep. 15, 2005, the entire specification of which is incorporated by reference. Also described herein is a pull-pull torque drive as an alternative to the torque shafts.

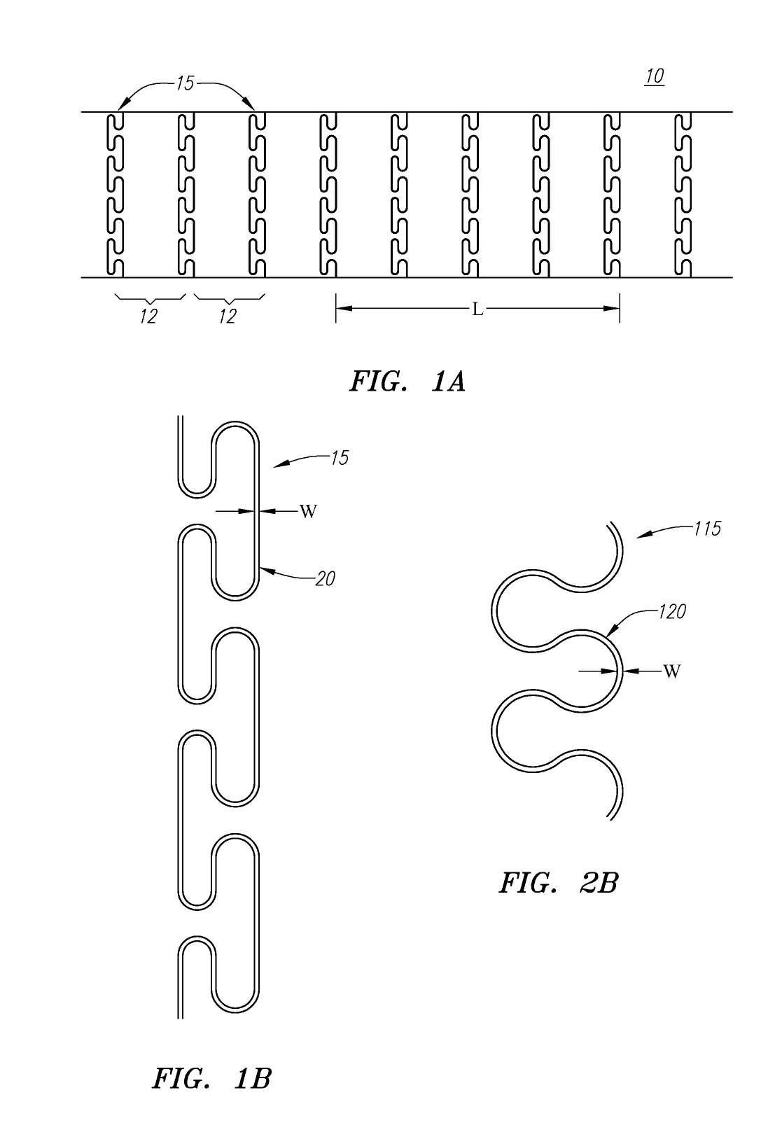

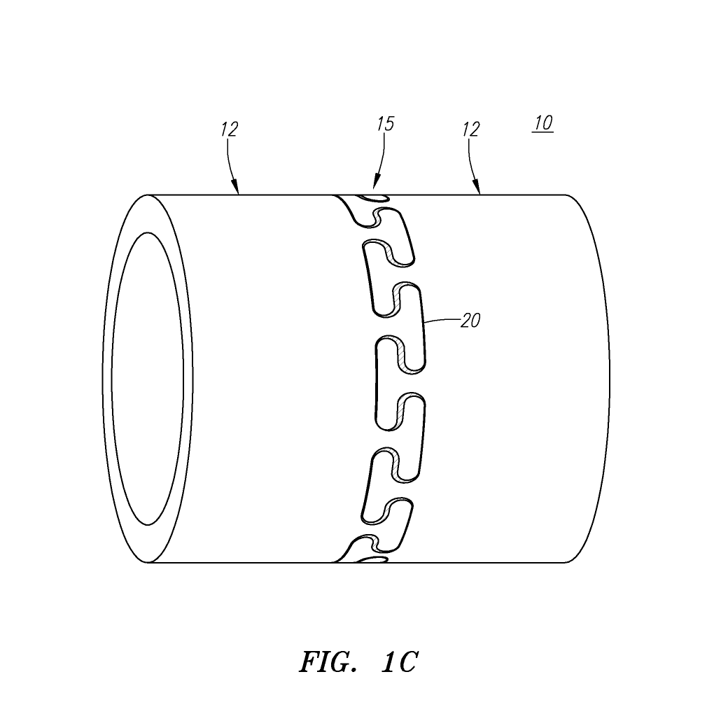

FIGS. 1A-1C show a torque shaft 10 according to an embodiment of the invention. The torque shaft 10 comprises a plurality of interlocking sections 12 cut into a steel tube. The sections 12 are linked together by interlocking geometry of slots 15. Each interlocking slot 15 extends around the circumference of the tube and comprises a plurality of interlocking features 20. The interlocking features 20 of each slot 15 connect two adjacent sections 12 on opposite sides of the slot 15. FIG. 1B shows an expanded view of one of the slots 15 and FIG. 1C shows an expanded perspective view of one of the slots 15. In this embodiment, each slot comprises T-shaped interlocking features 20. FIGS. 2A-2B show a torque shaft 110 according to another embodiment, in which each slot 115 comprises teardrop-shaped interlocking features 120. The geometry of the interlocking features can be any shape that interlocks.

In the preferred embodiment, the torque shaft is fabricated by laser cutting the slots into a steel tube. This may be done by moving the steel tube across a stationary laser under computer control to precisely cut the slots. Laser cutting is well known in the art for fabricating, e.g., stents.

Turning to FIGS. 1B and 2B, each slot 15,115 has a width W defined by the width of the laser cut. The slot width W creates space between adjacent sections that allow adjacent sections 12,112 to move slightly relative to each other. This movement allows adjacent sections 12,112 to bend at a slight angle (e.g., 1-2 degrees) relative to each other. The larger the slot width W, the more adjacent sections 12,112 can bend relative to each other.

The flexibility of the shaft 10,110 per unit length L depends on the amount that adjacent sections 12,112 can bend relative to each other and the number of slots 15,115 per unit length L. Since the amount that adjacent sections 12,112 can bend is determined by the slot width W, the flexibility of the shaft 10,110 per unit length is determined by the slot width W and the number of slots 15,115 per unit length L. The flexibility of the shaft 10,110 is approximately independent of the shape of the interconnecting features of the slots.

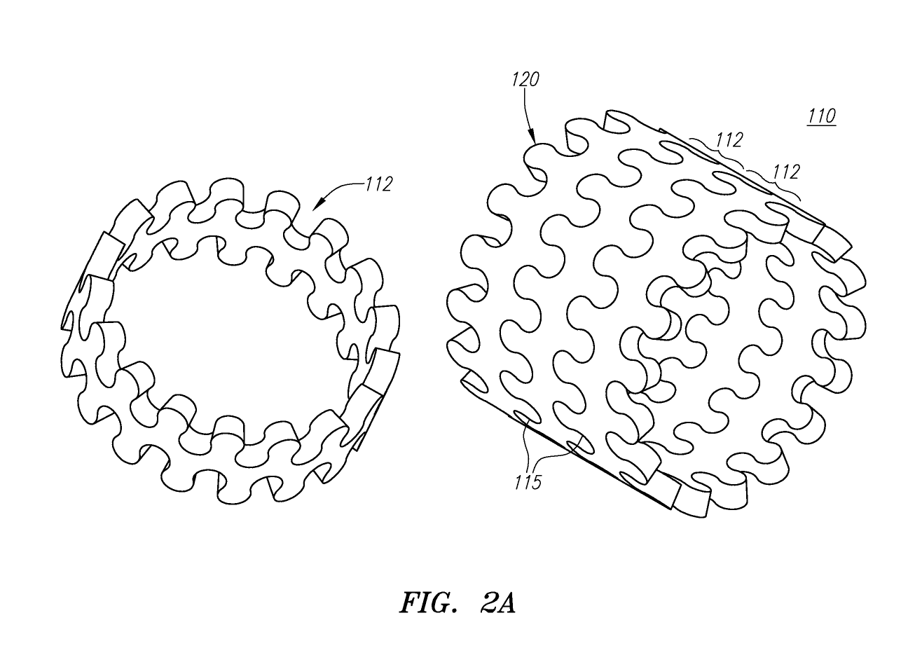

The interlocking slots 15,115 allow the shaft 10,110 to be flexible while enabling the shaft 10,110 to transmit torque applied at one end of the shaft to the other end of the shaft. The torque transferring capability of the shaft 10 is illustrated in FIG. 3, which shows an expanded view of two adjacent interlocking features 20 of a slot 15. As the shaft 10 is rotated about it longitudinal axis in the direction indicated by the arrow, the adjacent interlocking features 10 of the slot 15 engage each other, at which point torque is transferred between the adjacent sections 12 of the slot 15.

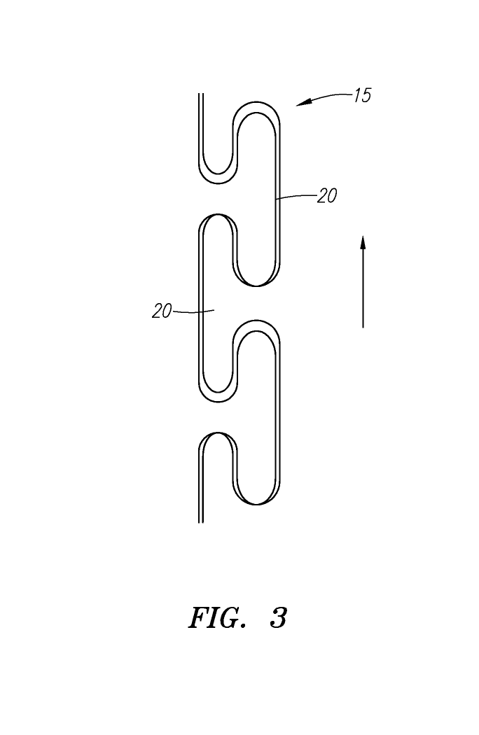

FIG. 4 shows an interlocking slot 215 according to another embodiment. In this embodiment, instead of a plurality of separate interlocking slots along the shaft, a continuous spiral or helical slot 215 runs along the length of the shaft 210. Alternatively, two or more helical slots may run along the length of the shaft. FIG. 4 also shows an example in which two contiguous interspaced helical slots 225 and 235 run along the length of the shaft 210 next to each other. The helical slots may have the same interlocking geometry or different interlocking geometries.

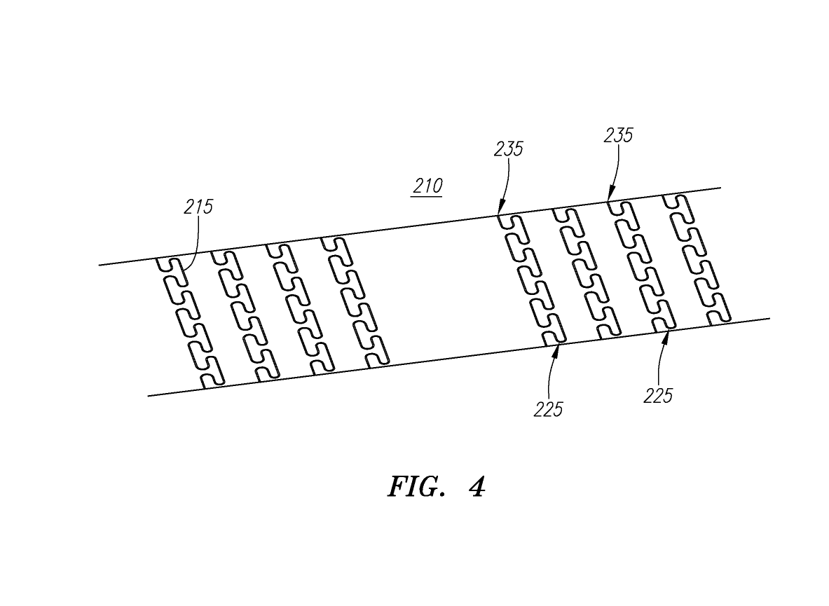

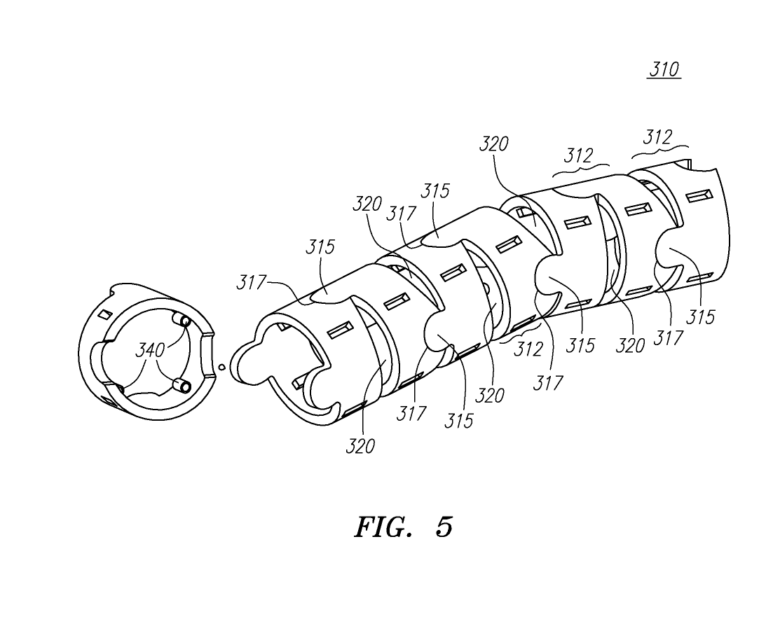

FIGS. 5-6 show a spot-link torque shaft 310 according to another embodiment of the invention. The torque shaft 310 comprises a plurality of interlocking sections 312. Each section 312 comprises two male interlocking features 315 on opposite sides of the section, and two female interlocking features 317 on opposite sides of the section and orientated 90 degrees with respect to the male interlocking features 315. The male interlocking features 315 have circular shapes and the female interlocking features 317 have corresponding inwardly curved shapes for receiving the male interlocking features 315 therein. The male interlocking features 315 of each section 312 fit into the female interlocking features 317 of an adjacent section 312. This fit enables adjacent sections 312 to pivot relative to each other about an axis. Each female interlocking feature 317 curves around the corresponding male interlocking feature 315 more than 180 degrees to prevent adjacent sections 312 from being pulled apart.

To provide space for adjacent sections 312 to pivot, portions of the tube forming the shaft are removed or cut away between the adjacent sections. In this embodiment, wedge-shaped portions of the tube are cut away between adjacent sections to provide pivot spaces 320. The pivot spaces 320 between adjacent sections allow adjacent sections 312 to pivot, e.g., 0-15 degrees, relative to each other.

The male interlocking features 315 of adjacent sections 312 are orientated at 90 degrees from each other. This is done to enable the interlocking features to hold the sections together. This is also done so that the pivot axes of the sections alternate 312 between two perpendicular axes. For example, in FIG. 6, the pivot axis of adjacent sections 312a and 312b is perpendicular to the pivot axis of adjacent sections 312a and 312c. The alternating pivot axes allow the torque shaft 310 to flex or bend in unlimited directions about the axis.

The male interlocking features 315 also enable the torque shaft 310 to transmit torque from one end of the shaft to the other end of the shaft. Each pair of male interlocking features 315 transmits torque between the corresponding adjacent sections 312 when the shaft is rotated along its longitudinal axis. In addition, the interlocking features 315 also provide column strength (compressive) and tensile strength to the shaft 310.

The torque shaft may include optional guides for steering cables. FIG. 5 shows an example in which the torque shaft 310 comprises four equally spaced guides 340 along its inner surface for receiving four steering cables. The guides may also be on the outer surface of the torque shaft.

The spot-link torque shaft has several advantages over the torque shaft with interlocking slots. One advantage is that adjacent sections of the spot-link torque shaft are able to pivot or bend to a much greater degree than adjacent sections of the torque shaft with interlocking slots. As a result, the spot-link torque shaft requires far fewer sections per unit length to flex or bend a given amount per unit length than the torque shaft with interlocking slots. This reduction in the number of sections reduces the amount of laser cutting required to fabricate the spot-link torque shaft compared to the torque shaft with interlocking slots.

Another advantage is that the spot-link torque shaft requires less rotation of the shaft before torque is transmitted from one end of the shaft to the other end of the shaft. Before torque can be transmitted from one end of a torque shaft to the other end, the rotational slack between each one of the adjacent sections of the shaft must be removed by rotating the shaft. Because the spot-link torque shaft has fewer sections than the torque shaft with interlocking slots, the spot-link torque shaft has less rotational slack that needs to be removed before toque is transmitted from one end of the shaft to the other end.

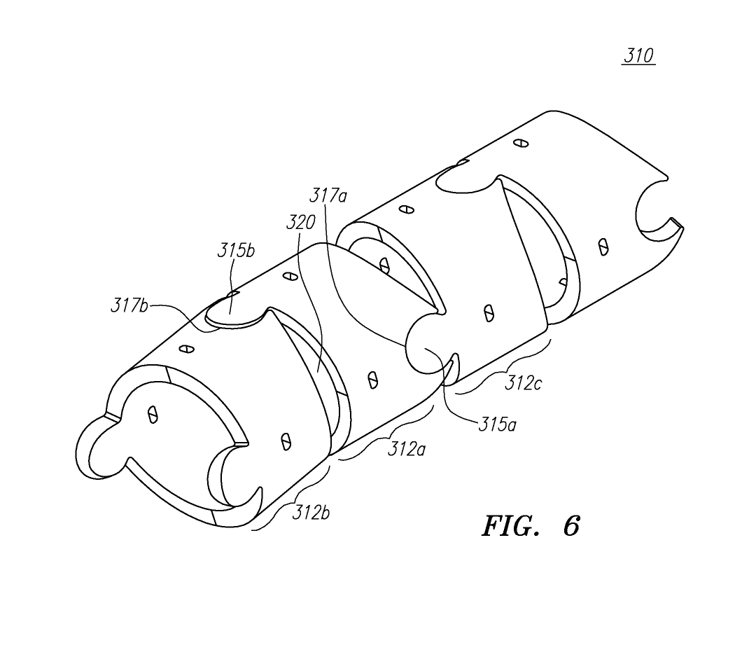

FIG. 7 shows a torque shaft 410 according to another embodiment. The torque shaft 410 comprises a plurality of sections 412 connected together by living hinges 415. Adjacent sections 412 are connected to each other by a pair of living hinges 415 on opposite sides of the shaft 410. The sections 412 are laser cut into a tube, in which thin portions of the tube are left connected between the sections 412 to form the living hinges 415. Preferably, the tube is made of a pliable metal, e.g., steel or Nitinol, or other pliable material that enables the living hinges to flex or bend without breaking. Slots 417 are cut on both side of each living hinge 415 to increase the length of the hinge 415 and hence the amount that each hinge can bend. The living hinges 415 enable adjacent sections 412 to flex or bend relative to each other. To provide space for adjacent section 412 to bend, portions of the tube are removed or cut away between adjacent sections. In this embodiment, wedge-shaped portions of the tube are cut away between adjacent sections to provide space 420 to flex.

Adjacent pairs of living hinges 415 are orientated at 90 degrees from each other. For example, in FIG. 7, the pair of living hinges 415a between adjacent sections 412a and 412b are orientated at 90 degrees from the pair of living hinges 415b between adjacent sections 412b and 412c. The 90 degree orientation between adjacent pairs of living hinges 415 enable the torque shaft 410 to flex or bend in more directions.

The torque shaft further comprises a pair of torque keys 430 between adjacent sections 412. Each pair of torque keys 430 extend from opposite sides of a section 412 and is received in a pair of slots 435 in an adjacent section 412. To allow adjacent sections 412 to bend about the hinges 415, the slots 435 are dimensioned so that the corresponding torque keys 430 can slide in the slots 435 to allow bending. The torque keys 430 transmit torque between adjacent sections 412 of the shaft when the shaft is rotated about its longitudinal axis by pushing against the side walls of the corresponding slots 435. The torque keys 430 may be contiguous with the sections 412 or may be made of separate pieces attached to the sections 412.

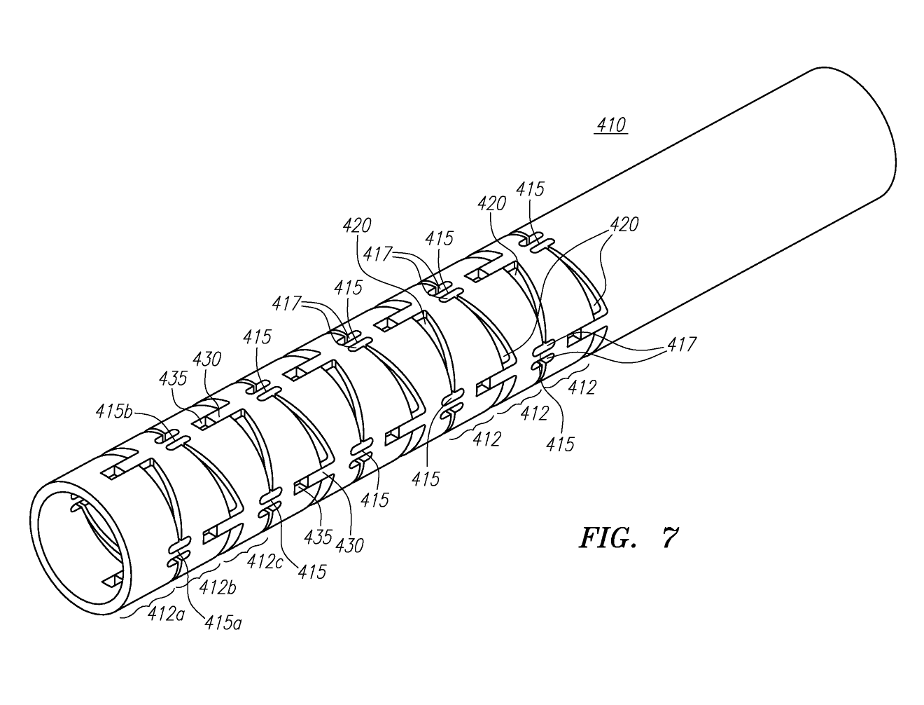

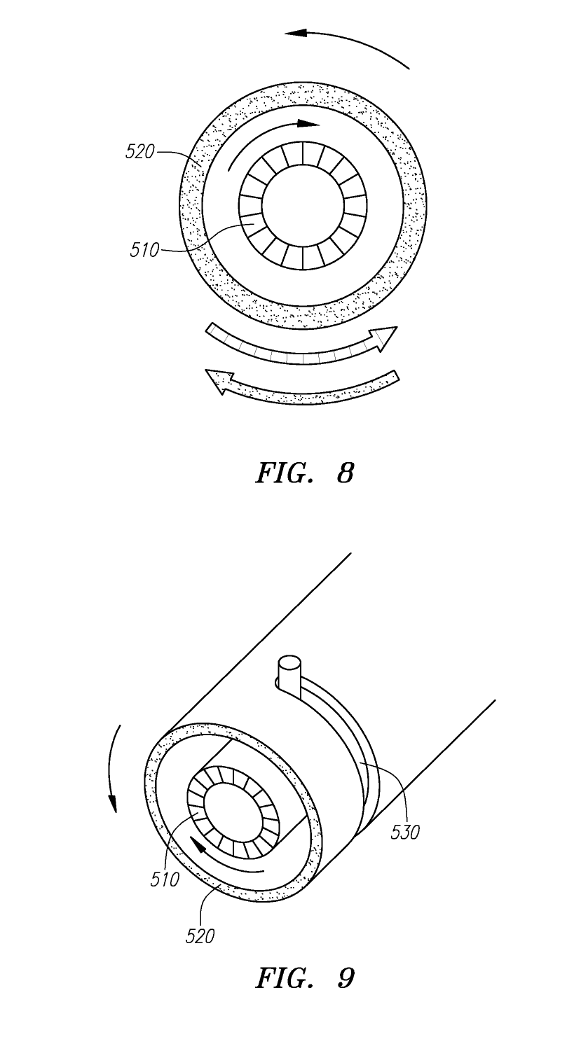

FIGS. 8-9 show two opposing torque shafts 510 and 520 with one of the torque shafts 510 within the other torque shaft 520. As explained above, a torque shaft has to be rotated by a certain amount at one end before torque is transmitted to the other end of the shaft. This amount of rotation is referred to as wind-up.

Since the two torque shafts 510 and 520 oppose each other in rotational direction, each torque shaft can be pre-wound or pre-loaded to remove wind-up before use. In FIG. 8, the outer torque shaft 520 is pre-wound in the counter clockwise direction and the inner torque shaft 510 is pre-wound in the clockwise direction as indicated by arrows. The torque shafts 510 and 520 are pre-wound until the wind-up is removed from each shaft 510 and 520. When the torque shafts 510 and 520 are pre-wound, the outer torque shaft 520 wants to unravel in the clockwise direction and the inner torque shaft 510 wants to unravel in the counter clockwise direction. To prevent the torque shafts 510 and 520 from unravel after they are pre-wound, an interlocking feature can be placed between the two torque shafts.

FIG. 9 shows an example of a pin 525 connected to the inner torque shaft 510 and received in a slot in the outer torque shaft 520. The pin 525 engages an end surface of slot 530, which prevents the two torque shafts 510 and 520 from unraveling. The slot 530 runs along part of the circumference of the outer shaft 520 to allow the ends of the torque shafts 510 and 520 to be rotated in opposing direction.

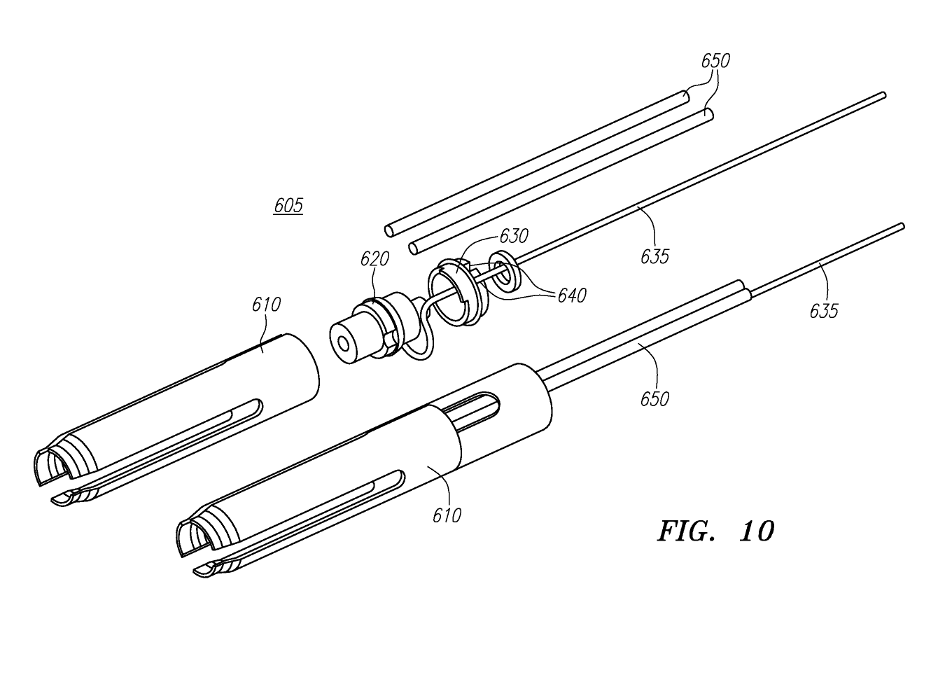

FIG. 10 shows an exploded and a perspective view of a pull-pull torque drive 605 according to an embodiment. The torque drive 605 comprises a slotted tube 610, a cable drum hub 620, and a sheave 630. The drum hub 620 is placed in the tube 610 and rotates on the sheave 630. The torque drive 605 further comprises two cables 635 running through coil pipes 650 (only one of the cables is shown in FIG. 10). The cables 635 are threaded through channels 640 in the sheave 630 and wound around the drum hub 620 in different directions. The end of each cable 635 is attached to the drum hub 620. FIG. 10 shows one of the cables 635 wound around the hub 620 in one direction. The other cable (not shown) is wound around the hub 620 in the opposite direction.

The cables 635 enable the cable drum hub 620 to be rotated in either direction with respect to the tube 610 by pulling one of the cables 635 axially. Pulling on one of the cables 635 causes that cable 635 to unwind around the hub 620 thereby rotating the hub 620. This also causes the other cable 635 to wind around the hub 620 so that the hub 620 can be rotated in the other direction by pulling the other cable 635.

The pull-pull torque drive 605 is useful for deploying a prosthetic heart valve in a patient, which is described in more detail in application Ser. No. 11/066,126, filed on Sep. 15, 2005.

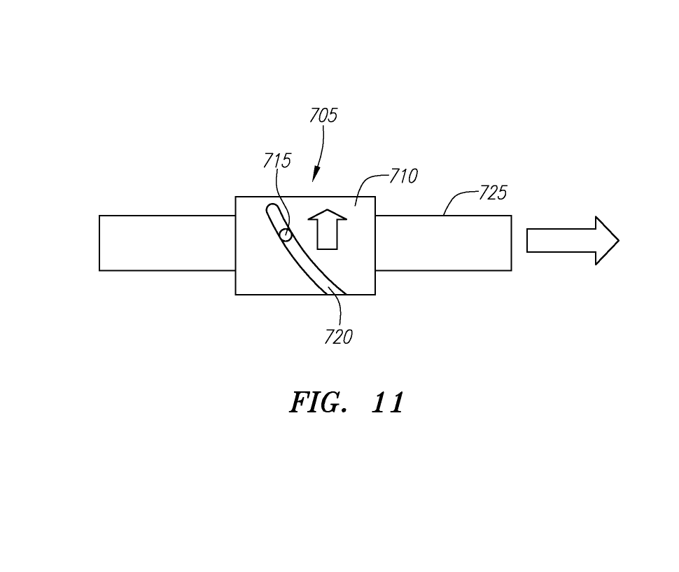

FIG. 11 shows a device 705 for translating axial movement of the shaft 725 into rotational movement of the shaft 710. This may be used for transmitting torque to the distal end of the shaft by applying axial force to the proximal end of the shaft. The device 705 comprises a cylindrical sleeve 710 with a curved slot 720 and a pin 715 connected to the shaft 725 that slides in the slot 720. When axial force is applied to the shaft 725, the pin 715 connected to the shaft travels along the curved slot 720 of the sleeve 710 causing the sleeve 710 to rotate.

Although the present invention has been described in terms of the presently preferred embodiments, it is to be understood that the disclosure is not to be interpreted as limiting. Various alterations and modifications will no doubt become apparent to those skilled in the art after having read this disclosure.

1. An apparatus for transmission of torque, comprising:
a plurality of rigid segments coupled together in an elongate configuration, wherein each segment comprises:
a first end comprising a male feature; and
a second end comprising a female feature, the female feature having a shape corresponding to the male feature such that the female feature is configured to receive the male feature of the first end of an adjacent rigid segment.

2. The apparatus of claim 1, wherein the plurality of rigid segments are coupled together in a flexible elongate configuration.

3. The apparatus of claim 1, wherein the male feature has a “T” like shape.

4. The apparatus of claim 1, wherein the male feature has a teardrop shape.

5. The apparatus of claim 1, wherein the male feature comprises a base and an end, the end having a greater width than the base.

6. The apparatus of claim 1, wherein the male feature is configured to interlock with the female feature.

7. The apparatus of claim 1, wherein the male feature comprises a base and an end and extends from the first end of the segment by a first length, the male feature having a width along the first length that does not increase when viewed from the base to the end.

8. The apparatus of claim 1, wherein each segment comprises:
a plurality of male features located along the periphery of the first end; and
a plurality of female features located along the periphery of the second end.

9. The apparatus of claim 8, wherein the plurality of rigid segments are coupled together in a flexible elongate configuration.

10. The apparatus of claim 9, wherein the male feature has a “T” like shape.

11. The apparatus of claim 9, wherein the male feature has a teardrop shape.

12. The apparatus of claim 9, wherein the male feature comprises a base and an end, the end having a greater width than the base.

13. The apparatus of claim 9, wherein the male feature comprises a base and an end and extends from the first end of the segment by a first length, the male feature having a width along the first length that does not increase when viewed from the base to the end.

14. The apparatus of claim 9, wherein the male feature is configured to interlock with the female feature.

15. The apparatus of claim 9, wherein the axial length of at least two segments is not the same.

16. The apparatus of claim 15, wherein the axial length of a first segment is a first length, and the apparatus comprises a plurality of segments adjacent to the first segment, the axial length of each of the adjacent segments being a second length not equal to the first length.

17. The apparatus of claim 16, wherein the plurality of the adjacent segments are located on one side of the first segment.

18. The apparatus of claim 9, wherein the axial length of each segment is the same.

19. The apparatus of claim 9, wherein the plurality of male features located along the periphery of the first end form a first pattern outline and the a plurality of female features located along the periphery of the second end form a second pattern outline, the first and second pattern outlines having generally the same shape.

20. The apparatus of claim 19, wherein the first and second pattern outlines are offset from each other.

21-56. (canceled)
